(19) United States
(12) Patent Application Publication
(10) Pub. No.: US 2026/0307701 A1
(43) Pub. Date: Oct. 8, 2026

(54) FOLDABLE SERVICE CART

(71) Applicant: Walter R. Tucker Enterprises, Ltd. D/B/A E-Z Red Company, Deposit, NY (US)

(72) Inventor: Robert CACCIABEVE, Denville, NJ (US)

(73) Assignee: Walter R. Tucker Enterprises, Ltd. D/B/A E-Z Red Company, Deposit, NY (US)

(21) Appl. No.: 19/640,093

(22) Filed: Apr. 6, 2026

Related U.S. Application Data
(60) Provisional application No. 63/783,388, filed on Apr. 4, 2025.

(51) Int. Cl. B62B 3/02; B62B 5/00

(52) U.S. Cl. CPC B62B 3/02; B62B 5/0006; B62B 2205/24; B62B 2301/04

(57) ABSTRACT

A foldable service cart having a top tray and a bottom tray. The top tray may be folded to provide use of just the bottom tray. The top and bottom trays may be folded to use the cart in confined places and for ease of storage.

### RELATED APPLICATION

This application claims the benefit of U.S. Provisional Application Ser. No. 63/783,388, filed Apr. 4, 2025, entitled “Foldable Service Cart,” which is incorporated herein by reference in its entirety.

### FIELD OF THE INVENTION

The present invention relates to a service cart. More particularly, the invention relates to a foldable service cart for use by a mechanic in a garage or the like.

### BACKGROUND OF THE INVENTION

Service carts are known in the art. However, the known service carts are not foldable to provide different functions. Additionally, the prior art service carts are difficult to move around a garage.

Accordingly, the known service carts have various shortcomings. These and other shortcomings of these devices are addressed by the present invention.

### SUMMARY OF THE INVENTION

The invention is directed to a foldable service cart.

An object of the invention is to provide a foldable service cart providing multiple functions of use for a user, including providing at least three different positions for use.

Another object of the invention is to provide a service cart having a top tray and a bottom tray, which trays are foldable.

Another object of the invention is to provide a service cart which when folded may be used in confined spaces.

Another object of the invention is to provide a service cart which includes a pegboard for the organization of tools and other items.

The invention is directed to a service cart as used, for example, by a mechanic in a service garage. The cart is foldable, thereby providing a number of advantages, including, but not limited to, (1) to provide a cart in an unfolded position having a top tray and a bottom tray; (2) in a first folded position the top tray is folded for use of the bottom tray only to receive larger items; (3) in a second folded position the top and bottom trays are both folded providing for a smaller tray footprint wherein the wheels will still maneuver which allows the user to have plenty of flat surface to place tools or parts while working in tight or confined places; and (4) in the completely folded position the cart takes up little space which allows for ease of storage. The service cart includes large rear wheels to help navigate a cluttered workshop without getting caught on cords or hoses and where most service carts cannot move to. A pegboard is provided to allow for pegboard organization of tools and other items, including magnetic organization of such items.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a perspective front and side view of the service cart of the invention.

FIG. 2 is a perspective rear and side view of the cart FIG. 1.

FIG. 3 is a front view of the cart of FIG. 1.

FIG. 4 is a side view of the cart of FIG. 1.

FIG. 5 is a rear view of the cart of FIG. 1.

FIG. 6 is a top view of the cart of FIG. 1.

FIG. 7 is a bottom view of the cart of FIG. 1.

FIG. 8 is a side view of the cart of FIG. 1 with the top tray folded down.

FIG. 9 is a side view of the cart of FIG. 1 with the top and bottom trays folded.

FIG. 10 is an exploded view of the cart of FIG. 1 showing the components of the cart.

FIGS. 11A-11G are cross-section views of the cart showing the folding of the cart from an open position to a closed position and illustrating the operation of the top tray assembly locking components and the bottom tray assembly locking components.

FIGS. 12A-12G are partial cross-section views of the cart showing the bottom tray lock release assembly.

FIG. 13 is a perspective rear and side view of the cart of FIG. 1 with tools and items stored on the pegboard.

FIG. 14 shows the cart of FIG. 1 in use with the top tray folded and a vehicle transmission on the bottom tray.

FIG. 15 shows the cart of FIG. 1 in a completely folded position to allow use in a confined area and showing tools on the pegboard of the cart.

### DETAILED DESCRIPTION OF THE PREFERRED EMBODIMENTS

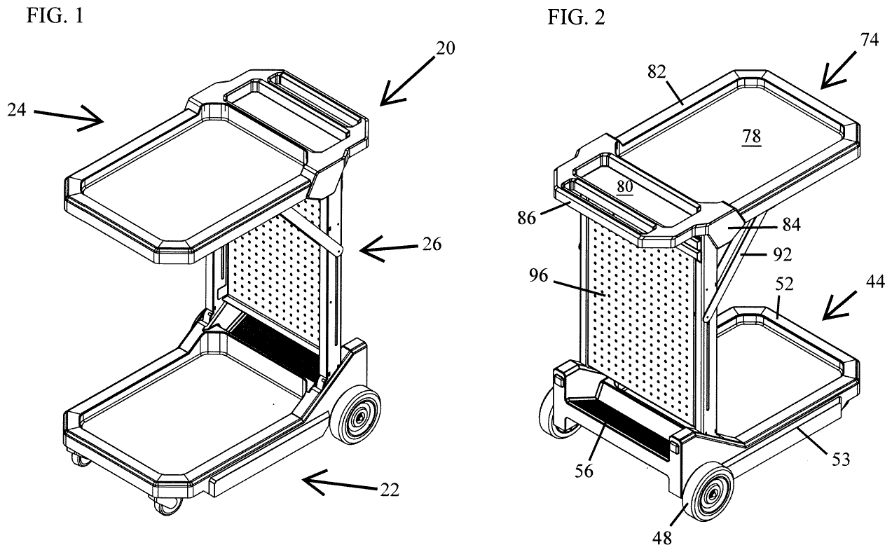

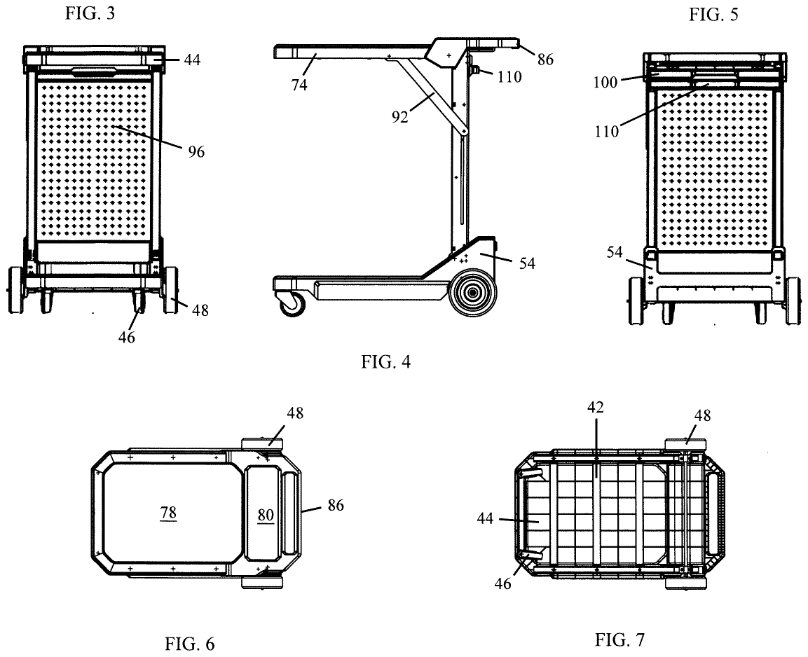

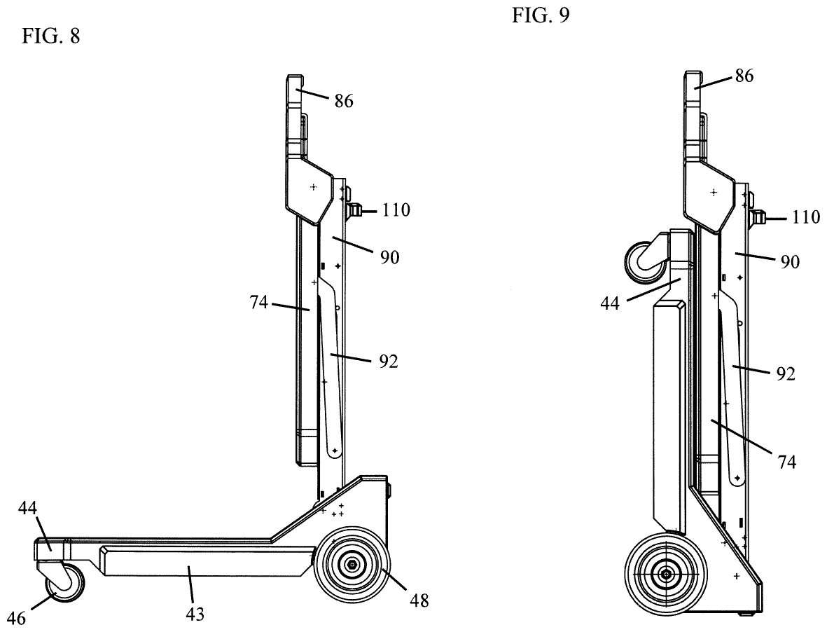

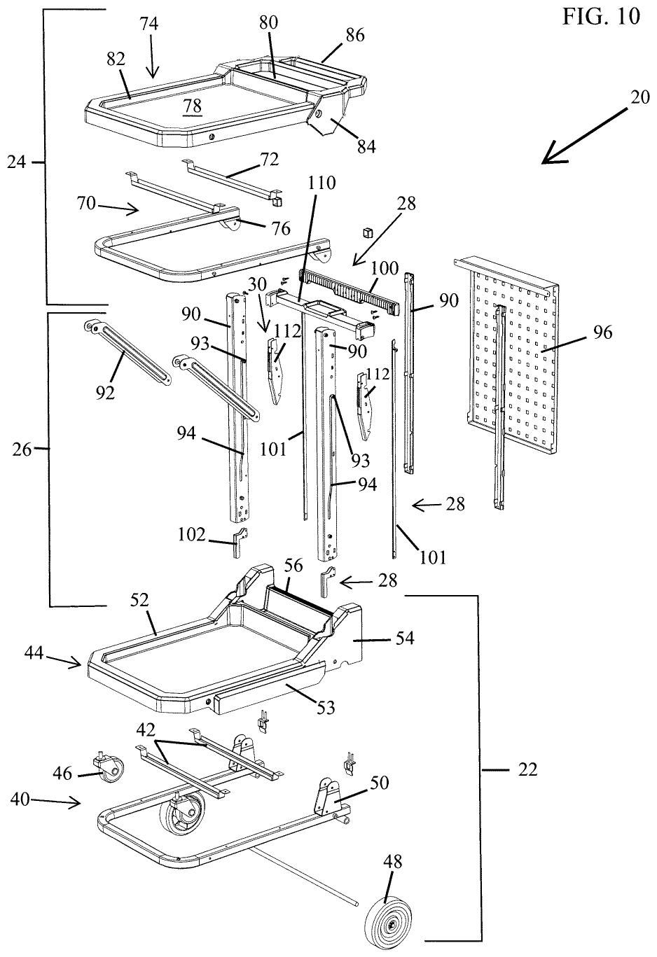

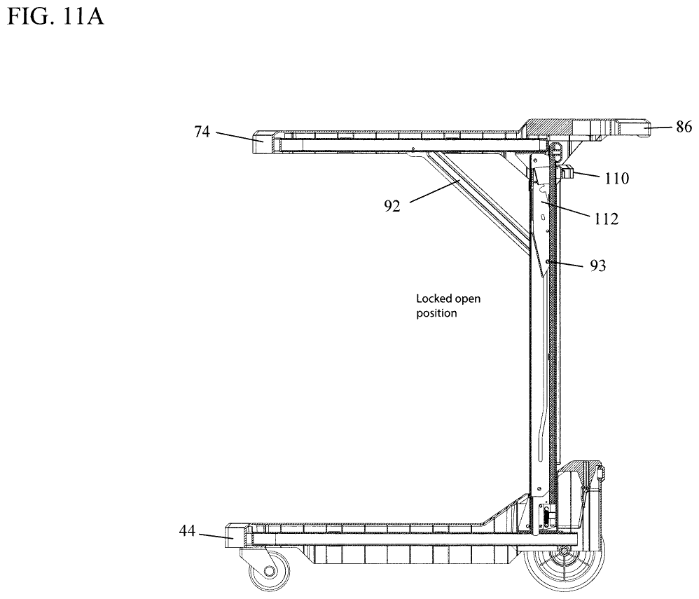

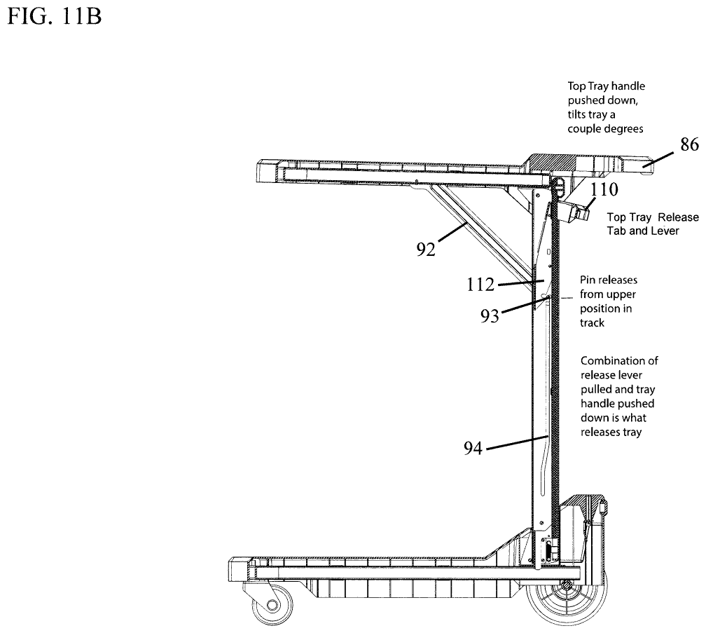

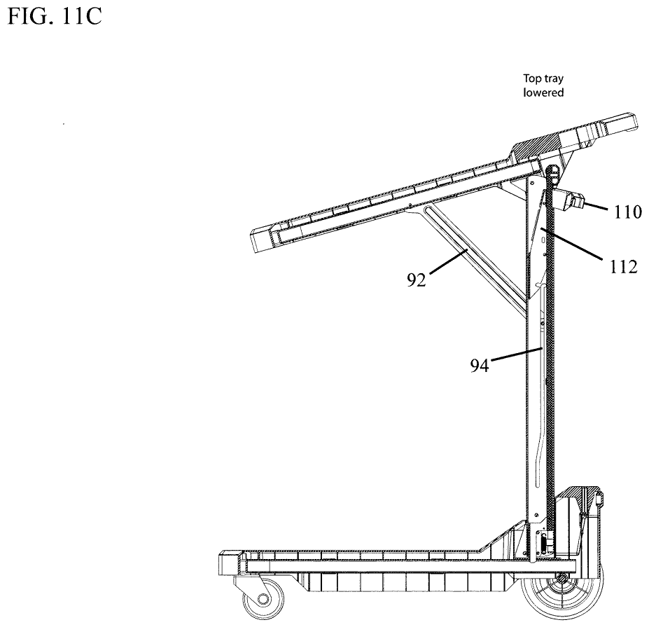

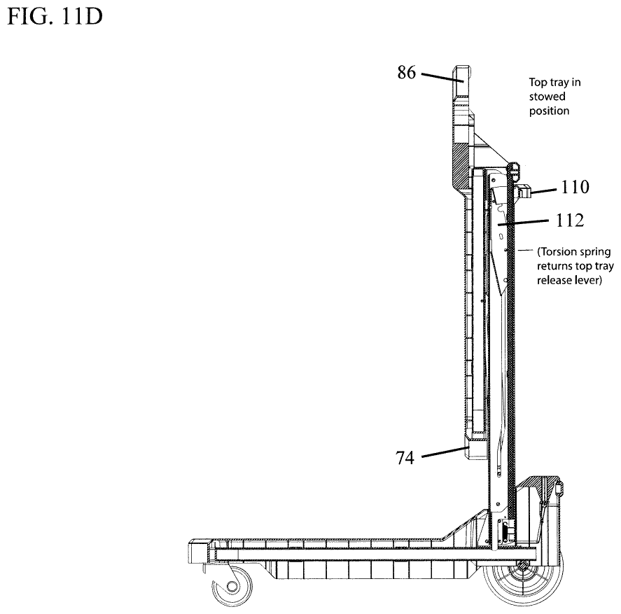

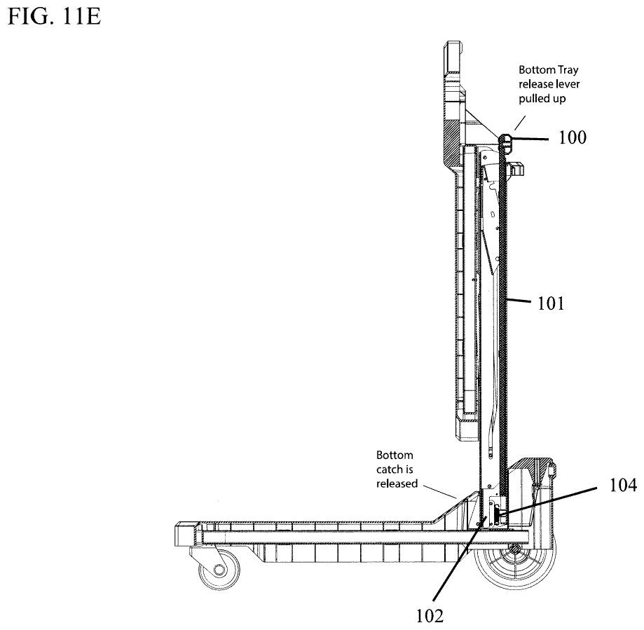

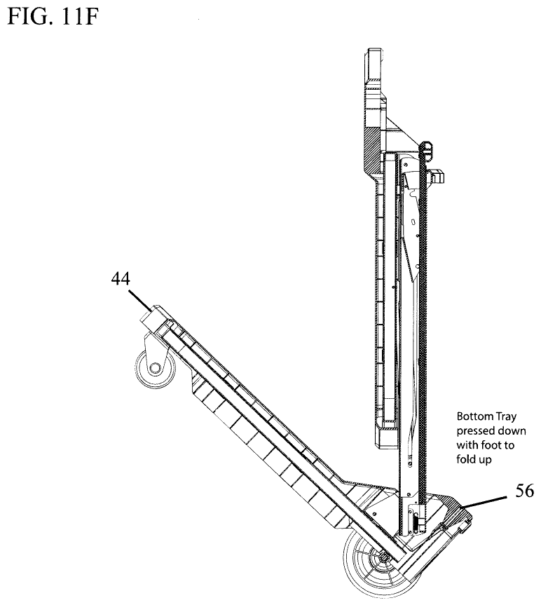

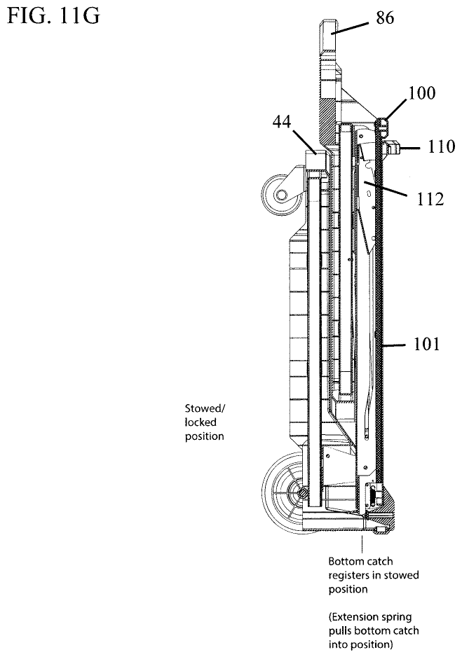

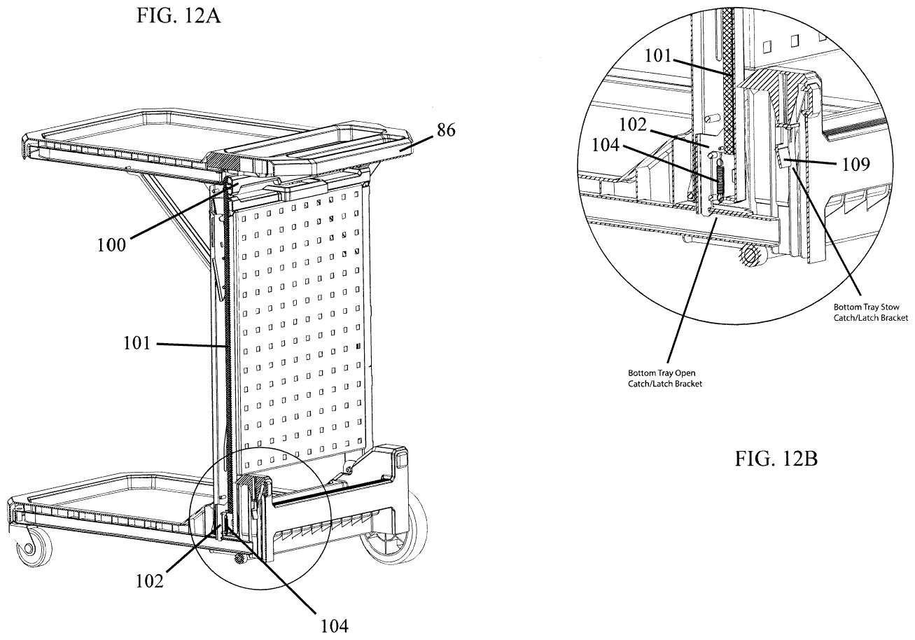

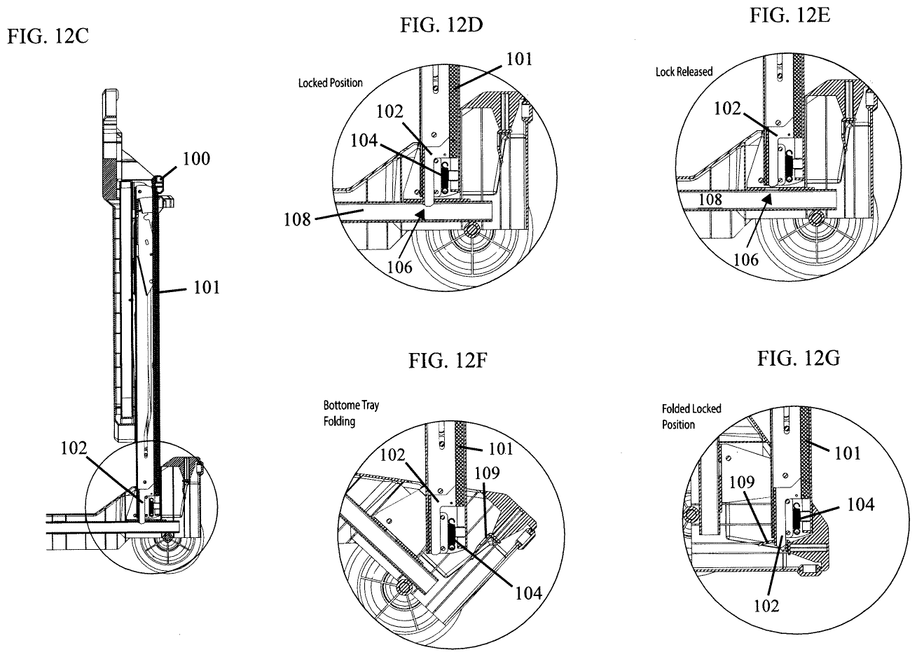

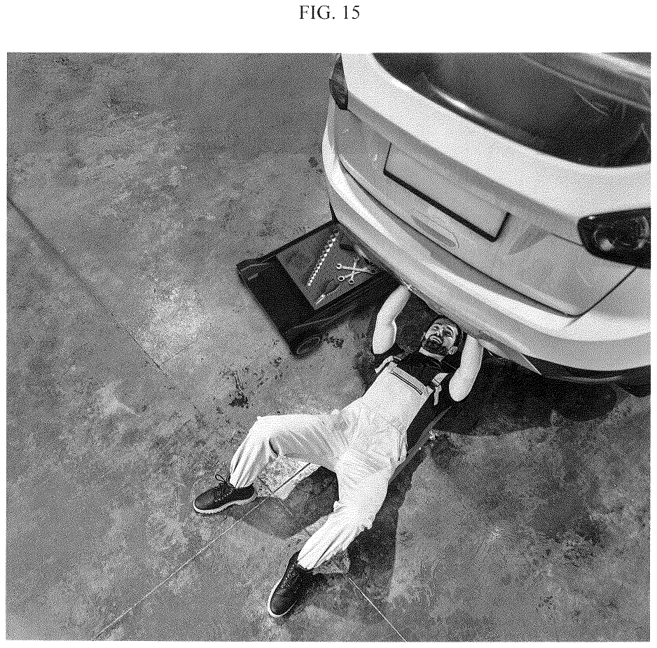

The invention is directed to a foldable service cart. Referring to FIG. 10, the foldable service cart is shown in exploded view with the components of the service cart. Referring to FIGS. 1-7, the foldable service cart is shown in an unfolded position having a top tray, a bottom tray, a pegboard, casters, wheels, a handle and means to fold the cart. FIG. 8 shows the cart with the top tray folded. FIG. 9 shows the service cart in a completely folded position. When in the completely folded position, the service cart may be stored or may be used in confined spaces such as shown in FIG. 15. FIGS. 11A-11G show the folding of the top and bottom trays of the cart. FIGS. 12A-12G show the locking mechanism for the bottom tray in further detail. The service cart as shown in the figures illustrates the structure and the various uses of the service cart and which are evident therefrom. The service cart of the invention will now be described in further detail.

Referring to the drawings, for example FIGS. 1-7 and 10, there is shown a service cart 20. The service cart 20 includes a bottom tray assembly 22, a top tray assembly 24, a side rail assembly 26 which connects the top and bottom tray assemblies 22 and 24, a bottom tray lock release assembly 28 and a top tray lock release assembly 30.

The bottom tray assembly 22 may be one or multiple components. In a presently preferred embodiment, the bottom tray assembly 22 includes a bottom tray support 40 having cross members 42 for receiving a bottom tray 44. The bottom tray support 40 will include front casters 46 which will swivel 360 degrees and rear wheels 48, the rear wheels being larger than the front casters to allow for easy movement of the cart in a work area. The bottom tray support includes stanchions 50 for connecting the bottom tray support to the bottom tray and the side rail assembly 26. The bottom tray 44 is constructed to hold one or more articles and has a raised periphery shoulder 52 and bumpers 53. The bottom tray 44 also includes corresponding stanchions 54 to mate with the bottom tray support stanchions 50. The bottom tray 44 further includes a foot support 56 for aiding in the moving of the top tray assembly and bottom tray assembly from or to a folded or unfolded position.

The top tray assembly 24 may be one or multiple components. In a presently preferred embodiment, the top tray assembly includes a top tray support 70 having cross members 72 for receiving a top tray 74. The top tray support will include stanchions 76 for connecting the top tray support to the top tray 74 and the side rail assembly 26. The top tray 74 is constructed to hold one or more articles in a bottom section 78 and a top section 80. Both top and bottom sections 78 and 80 include a raised periphery shoulder 82. The top tray also includes corresponding stanchions 84 to mate with the top tray support stanchions 76. The top tray further includes a handle 86 for holding and moving the cart.

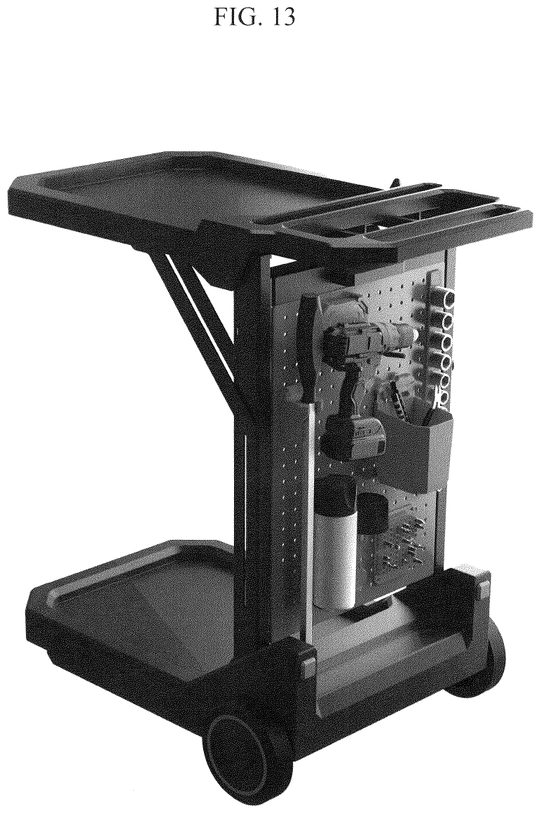

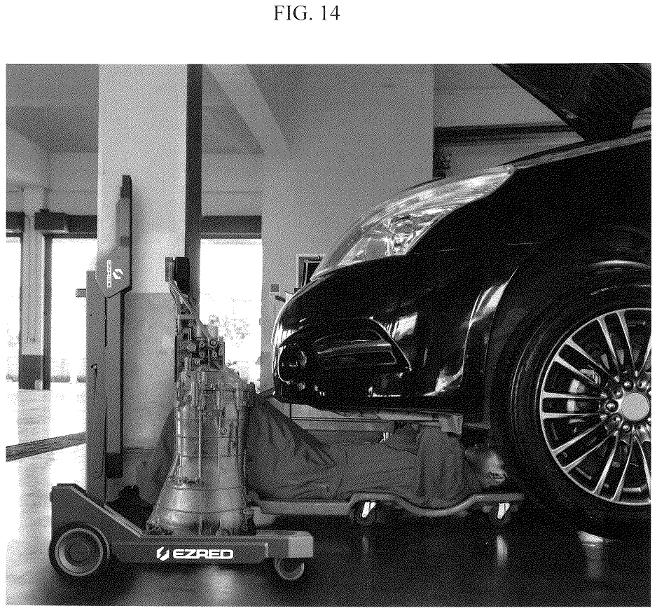

The side rail assembly 26 includes rails 90 for connecting the bottom tray assembly 22 to the top tray assembly 24 by fasteners or the like. The rails 90 have folding support arms 92 which are connected to each rail 90 and to the top tray assembly 24 thereby allowing the top tray assembly 24 to be folded from a horizontal use position as shown for example in FIG. 1 to a vertical non-use position as shown for example in FIG. 8, including as discussed below. The arms 92 are locked by pins 93 on rail 90 and slide along a slot 94 in rails 90. The rails 90 are hollow for receiving components of the top and bottom tray lock release mechanisms 28 and 30. The side rail assembly may have attached thereto a pegboard 96 for receiving tools or other articles on pegboard hooks as shown in FIG. 13.

Referring, for example, to FIGS. 10-12, the top and bottom tray lock releases are disclosed. The bottom tray lock assembly 28 includes a release bar 100 with release legs 101 which is pulled upward to release a lock catch 102. Release bar 100 is grasped to move up and down as discussed below. Tension spring 104 will bring release bar 100 back in place. The top tray lock release assembly 30 includes a pull tab 110 attached to levers 112. Tab 110 is pulled toward the user to release the top tray from locking pins 93 as discussed below.

Referring to FIGS. 12A-12G, the bottom tray lock release assembly will be described in further detail. FIG. 12A shows a partial cross-section of the cart. FIG. 12B is an enlarged portion of FIG. 12A. The Figures show release bar 100, release legs 101, lock catch 102 and torsion spring 104. The lock catch 102 is in slot 106 of catch latch bracket 108. FIG. 12C shows a cross-section partial side view of the cart with the bottom tray assembly in a locked position as shown in FIG. 12D. When the release bar 100 is pulled upward, catch latch 102 moves out of slot 106 and the bottom tray assembly may be folded as shown in FIGS. 11F and 12F. When folded to a closed position as shown in FIGS. 11G and 12G, bottom tray catch latch bracket 109 locks the bottom tray assembly in place allowing for use of the service cart as shown in FIG. 15 or for easy storage of the service cart in an upright position as shown in FIG. 9.

Referring to FIGS. 11 and 12, there is shown various views of the service cart in cross-section showing the closure of the service cart from the open position to a closed position, including the various components of the service cart (the pegboard not included). FIG. 11A shows the service cart in a fully locked open position. There is shown the pull tab 110 attached to levers 112 which engage pins 93 to lock the arms 92 in place. FIG. 11B shows the top tray release pull tab 110 being pulled outwardly and releasing lever 112 from pin 93. Levers 112 having been released from the locked position, the user pushes tray handle 86 down and the top tray is released and may be lowered with arms 92 sliding along slots 94. FIG. 11C shows the top tray being folded and FIG. 11D shows the top tray assembly being in a closed or stowed position. Pull tab 110 returns to its original position by use of a torsion spring (not shown). FIG. 11E is similar to FIG. 11D and shows the bottom tray release bar 100 being pulled up to release the bottom catch 102 which has locked the bottom tray assembly into place. FIG. 11F shows the bottom tray assembly being moved to a closed position by a user pressing down on the bottom tray foot support 56. FIG. 11G shows the service cart in the stowed and locked position. The bottom catch 109 registers to keep the cart in a locked position by an extension spring pulling the catch into the locked position.

To open the service cart from the closed position as shown in FIGS. 9 and 11G, the bottom tray assembly is released by pulling the bar 100 up, while simultaneously stepping on the foot rest 56; then the bottom tray assembly is lowered by the user picking up their foot and guiding the bottom tray to the ground and locking it into place. The top tray is then raised into an open position by pushing the handle 80 down and levers 112 grasp pins 93 to lock the top tray into the open position.

As seen above, the foldable service cart of the invention is quite useful in an environment of use. It is easy to use and provides the user with multiple functions.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A foldable service cart comprising
a bottom tray assembly having a bottom tray, one or more casters and two wheels;
a top tray assembly having a top tray;
a side rail assembly having at least two rails connecting the top tray assembly and the bottom tray assembly;
a bottom tray lock release assembly including means to lock and unlock the bottom tray assembly for folding; and
a top tray lock release assembly including means to lock and unlock the top tray assembly for folding, wherein the service cart is foldable and provides at least three different use positions.

2. The foldable service cart of claim 1 further comprising a pegboard.

3. The foldable service cart of claim 1 wherein the bottom tray assembly includes a bottom tray support and the top tray assembly includes a top tray support.

4. The foldable service cart of claim 1 wherein the bottom tray assembly includes a foot support.

5. The foldable service cart of claim 4 wherein the bottom tray assembly includes one or more bumpers.

6. The foldable service cart of claim 1 wherein the top tray assembly includes at least two separate areas for holding articles.

7. The foldable service cart of claim 1 wherein the top tray includes a handle.

8. The foldable service cart of claim 1 wherein the bottom tray release lock assembly includes a bar adapted to be moved upwards to release a locking member.

9. The foldable service cart of claim 1 wherein the top tray lock release assembly includes a pull tab adapted to be pulled outwardly to release a locking member.

10. A foldable service cart comprising
a bottom tray assembly having a bottom tray support, a bottom tray, a foot support, one or more casters and two wheels;
a top tray assembly having a top tray support and a top tray;
a side rail assembly having at least two rails connecting the top tray assembly and the bottom tray assembly;
a bottom tray lock release assembly including means to lock and unlock the bottom tray assembly for folding; and
a top tray lock release assembly including means to lock and unlock the top tray assembly for folding, wherein the service cart is foldable and provides at least three different use positions.

11. The foldable service cart of claim 10 further comprising a pegboard.

12. The foldable service cart of claim 11 wherein the top tray assembly includes at least two separate areas for holding articles.

13. The foldable service cart of claim 12 wherein the top tray includes a handle.

14. The foldable service cart of claim 13 wherein the bottom tray release lock assembly includes a bar adapted to be moved upwards to release a locking member.

15. The foldable service cart of claim 14 wherein the top tray lock release assembly includes a pull tab adapted to be pulled outwardly to release a locking member.
